(19) United States
(12) Patent Application Publication
(10) Pub. No.: US 2011/0284603 A1
(43) Pub. Date: Nov. 24, 2011

(54) APPARATUS FOR SECURING A MOTORBIKE WITHIN A TRUCK BED

(76) Inventor: Matthew Reyes, Alpharetta, GA (US)

(21) Appl. No.: 12/835,713

(22) Filed: Jul. 13, 2010

Related U.S. Application Data
(60) Provisional application No. 61/224,911, filed on Jul. 13, 2009.

(51) Int. Cl. B60R 9/00; B60P 3/073

(52) U.S. Cl. 224/403; 410/3

(57) ABSTRACT

Disclosed is an apparatus for securing a plurality of motorbikes in a truck bed without the need for straps. The apparatus simply attaches to the truck bed in much the same manner as a conventional toolbox attachment. The motorbikes fit within the truck bed while allowing for simultaneous storage of tools and other items.

### RELATED APPLICATION

This application relies upon U.S. Provisional Application Ser. No. 61/224,911 filed Jul. 13, 2009, the content of which is hereby incorporated in its entirety.

### TECHNICAL FIELD

The present invention relates generally to an apparatus for securing a motorbike in a truck bed and in greater detail the apparatus relates to the securing of a plurality of motorbikes in the back of a pickup truck bed without using straps which can damage the motorbike.

### BACKGROUND

Dirt bikes and other motorcycles are commonly transported in the back of pickup trucks. However, the process of loading and securing them, especially two motorcycles in one truck, can be very tedious and time consuming when using straps or various other tie down methods. Furthermore, motorcycles strapped down in this fashion are vulnerable to theft as someone can easily undo the straps and steal your expensive bikes.

Pick-up trucks, having an open cargo area behind the driver's compartment, are useful vehicles for transporting a motorcycle, especially if the motorcycle is carried erect within the cargo area. However, because the usual length of the motorcycle is comparable to the usual length of the cargo area, the motorcycle must be oriented in the director of motion of the truck. Special securing means become necessary to prevent movement of the motorcycle in the rolling and lateral directions. Since the pick-up truck may be left unattended in the course of travel, it is also necessary to provide means to prevent theft of the motorcycle.

One other common issue for truck owners who frequently transport motorcycles arises from having a tool box mounted in their pickup bed. Although the ability to store tools and gear is attractive, the box itself takes up valuable room and often makes it impossible to transport bikes due to an inadequate amount of loading space. Currently there is no type of apparatus that combines the appeal of a standard one piece truck toolbox and the versatility to transport up to two motorcycles with a simple latch and go process (or possibly latch free process).

A certain amount of specialized paraphernalia is required for the full utilization of a motorcycle. Such paraphernalia includes a safety helmet and other specialized wearing apparel, tools for maintenance and repair, spare parts, lubricants, tire changing equipment, supplies for overnight trips, and still other items. It is necessary to accommodate said items in a storage facility which affords protection. Because the motorcycle, once positioned in the cargo area, occupies a major and central portion of said area, little space is left for conventional storage boxes. Even if conventional boxes could be fitted about the motorcycle, accessibility to such boxes would be difficult.

Thus, what is needed is an apparatus capable of carrying multiple motorbikes in a truck bed while allowing one store other gear.

### SUMMARY

The present invention comprises an apparatus for securing a plurality of motorbikes in a truck bed without the need for straps. The apparatus simply attaches to the truck bed in much the same manner as a conventional toolbox attachment. The motorbikes fit within the truck bed while allowing for simultaneous storage of tools.

In greater detail there is provided an apparatus for securing a motorbike within a truck bed, wherein the truck bed is defined by two opposed parallel sidewalls, a floor and a headwall perpendicular to the opposed sidewalls. The apparatus comprises a frame residing within and connected to the truck bed; the frame extends out and is perpendicular to the two side walls. The apparatus includes at least two tire receiving gaps formed within the frame. Additionally, included is an anchoring device for securing the motorbike to the frame wherein the anchoring device resides within each of the tire receiving gaps.

Additionally, the anchoring device is slidably attached to the frame, whereby the height of the device can be adjusted to fit the size of the motorbike to be secured. Furthermore, the anchoring device is pivotively attached to the frame for adjusting its height. In an embodiment the anchoring device includes a clamping mechanism for securing the forks of the motorbike to the frame and the anchoring device is selectively detachable from the frame. The motorbike may also be locked into the anchoring device. A stand may also be included for interfacing with the anchoring device when the device is removed from the truck bed.

In a further embodiment the apparatus includes storage compartments operatively sized to fit within the frame, whereby the storage compartments provide the capacity for housing various items. Additionally included is a pair of tire gap storage compartments pivotively connected to the frame and operatively sized to fit within the tire receiving gaps, whereby the tire gap storage compartments conceal the gap when not in use and pivotively fold up and out of the way when the gap houses the motorbike. Other included storage compartments include those housed within the frame on either side of the tire receiving gap and include a hinged lid whose opening is supported by a hydraulic hinge.

A further embodiment of the apparatus includes a housing residing within and connected to the truck bed. The housing extends out and is connected to each of the opposed sidewalls and is parallel to and adjacent to the headwall. The apparatus includes at last two tire receiving gaps formed within the housing and storage compartments formed within the housing. The housing further includes an anchoring device for securing the motorbike to the housing wherein the anchoring device resides within each of the tire receiving gaps of the housing.

The anchoring device of the housing is adjustably attached to the housing whereby the height of the device can be adjusted to fit the size of the motorbike to be secured. The anchoring device includes a clamping mechanism for securing the forks of the motorbike to the frame and the anchoring device is selectively detachable from the frame. Additionally, a locking mechanism is attached to the anchoring device for selectively locking the motorbike into the device whereby the theft of the motorbike can be deterred.

### DRAWING

In the Drawing:

FIG. 1 depicts the frame embodiment of the present apparatus for securing a motorbike within a truck bed showing the frame residing within and connected to the truck bed;

FIG. 2 is a further depiction of the apparatus for securing the motorbike showing the apparatus attached the walls of the truck bed and the compartments and the anchoring devices pivotively attached to the apparatus;

FIG. 3 illustrates the tire gap storage compartments in place over the tire receiving gaps and the accompanying compartments in the housing;

FIG. 4 is a further depictions of the tire gap storage compartments pivotly connected to the housing both pulled up and closed; and

FIG. 5 shows the anchoring device slidably attached to the frame or housing of the present apparatus in cooperation with the tire gap storage compartments.

### DETAILED DESCRIPTION

Disclosed is an apparatus for securing a plurality of motorbikes in a truck bed without the need for straps. The apparatus simply attaches to the truck bed in much the same manner as a conventional toolbox attachment. The motorbikes fit within the truck bed while allowing for simultaneous storage of tools and other items.

In an embodiment of the apparatus for securing a motorbike a user could in the operation of the invention first fold back or remove the optional tire gap concealing compartment. Then one could then slide the anchoring device into the tire receiving gap and adjust the height of the anchoring device according to the size (ride height) of the motorbike being transported. Next, using loading ramps one would load the bike(s) into the truck bed and slide the front tire of the motorcycle into the tire gap provided on the toolbox. By doing so, the motorcycle's front forks engage the anchoring device and become latched and freestanding (in an erect position). This latch apparatus can then be locked to secure the bike(s) from theft. To remove the motorcycle(s) simply unlatch the anchoring device and reverse the loading process.

The apparatus safely and efficiently transports motorbikes without the use of tedious tie down straps. The apparatus can store tools and gear while locking the motorcycles in a fixed position to prevent them from theft.

In the construction of the apparatus it can be made of diamond plate similar to standard toolboxes. In a further example, the apparatus can be made of plastic, carbon fiber, steel, aluminum, or various other weldable metals. Regarding demission, by way of example and not limitation the apparatus may be sized like a standard truck toolbox (one rectangular shaped unit about 5 ft wide by 2 ft long by 3 ft deep). Other variations of the dimensions can be applicable such as a low profile style, high profile style, and the like.

The cutout spots for the motorcycle(s) front tires to slide into, and these gaps or cut outs can be covered with whatever material the toolbox is made of when the motorcycles are not being transported (foldable or removable gap concealing compartments). Filling those gaps can give the toolbox a standard look. In an embodiment, the apparatus may be comprised of up to three or more separate compartments or lids that all open from the top of the toolbox individually.

Latches for securing the motorcycles will be housed in a lockable manner. Different anchoring devices like pivotal tire chalks can be tested to achieve the overall look and result. Various colors can be used for the toolbox's final finish. The apparatus is applicable for both truck beds and trailers. In the specification, the term “truck beds” includes trailers.

In an embodiment, the apparatus may be way of example have about a 10-14″ wide tire gap (up to two gaps for transporting two bikes) that will be about 8-18″ in length. This gap can give the motorcycles front tire the ability to slide in and become secured for transport. A further example anchoring device includes the motorbike's front tire could be secured in the gap with a device that pinches the tire like a clamp or using other anchoring devices.

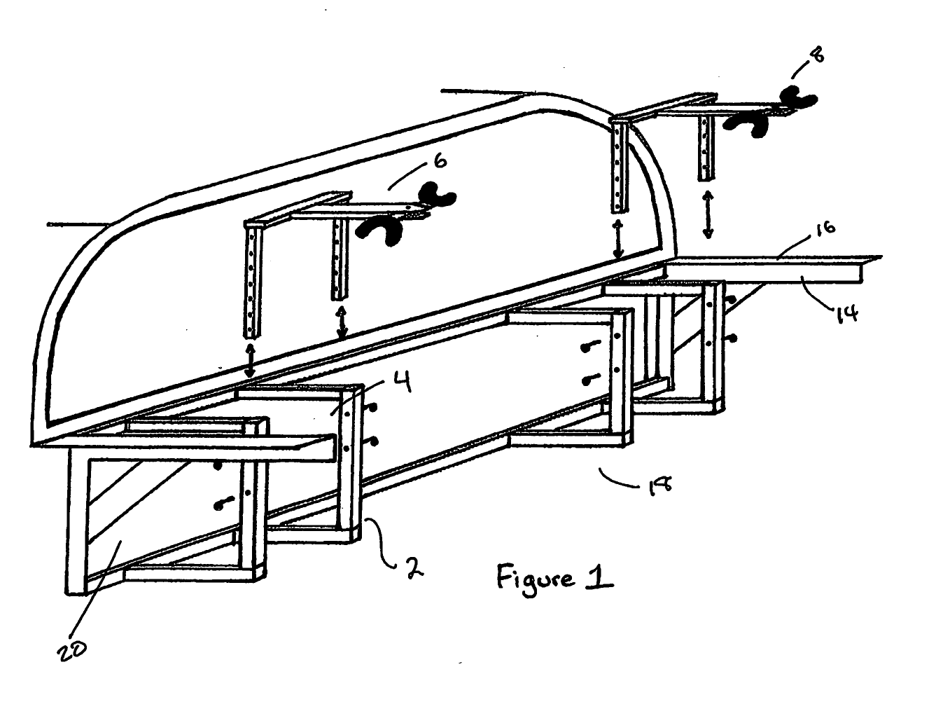

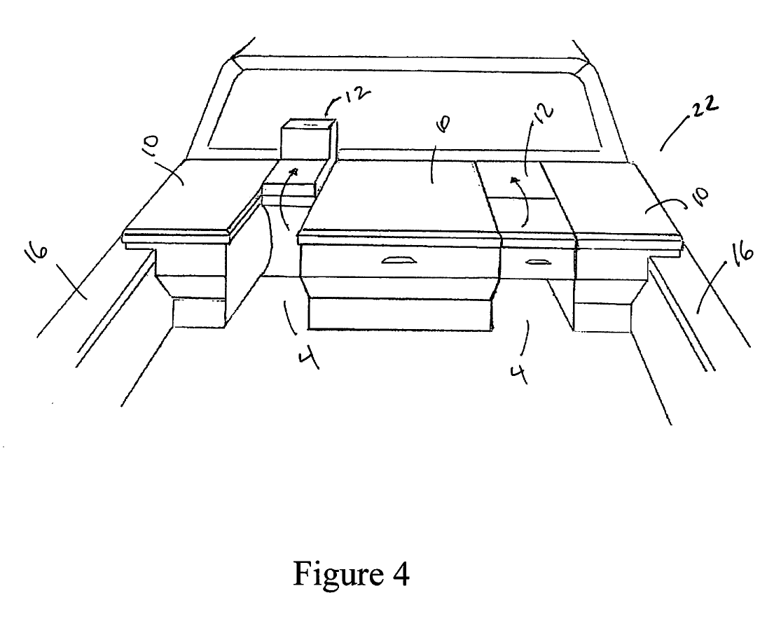

Turning now to the attached drawings, wherein like reference numerals will refer to like elements throughout, FIGS. 1-5 illustrate the various embodiments of the present apparatus.

FIG. 1 depicts the frame 2 embodiment of the present apparatus. Illustrated is the apparatus for securing a motorbike within a truck bed 14, wherein the truck bed 14 is defined by two opposed parallel sidewalls 16, a floor and a headwall 20 perpendicular to the opposed sidewalls 16. The apparatus comprises a frame 2 residing within and connected to the truck bed 14; the frame 2 extends out and is perpendicular to the two side walls 16. The apparatus includes at least two tire receiving gaps 4 formed within the frame 2. Additionally, included is an anchoring device 6 for securing the motorbike to the frame 2 wherein the anchoring device 6 resides within each of the tire receiving gaps 4.

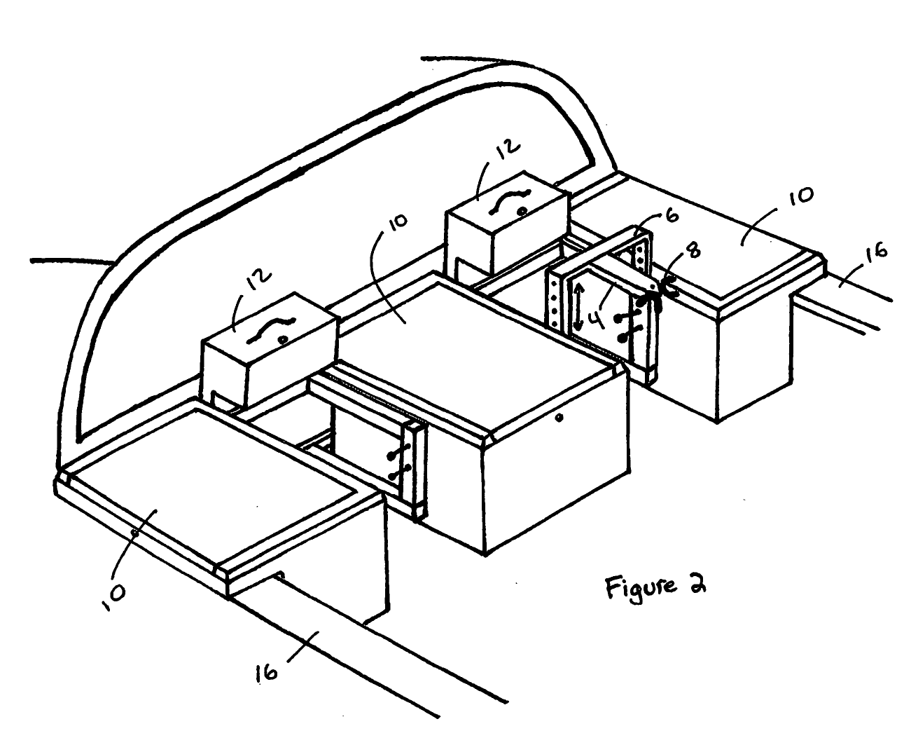

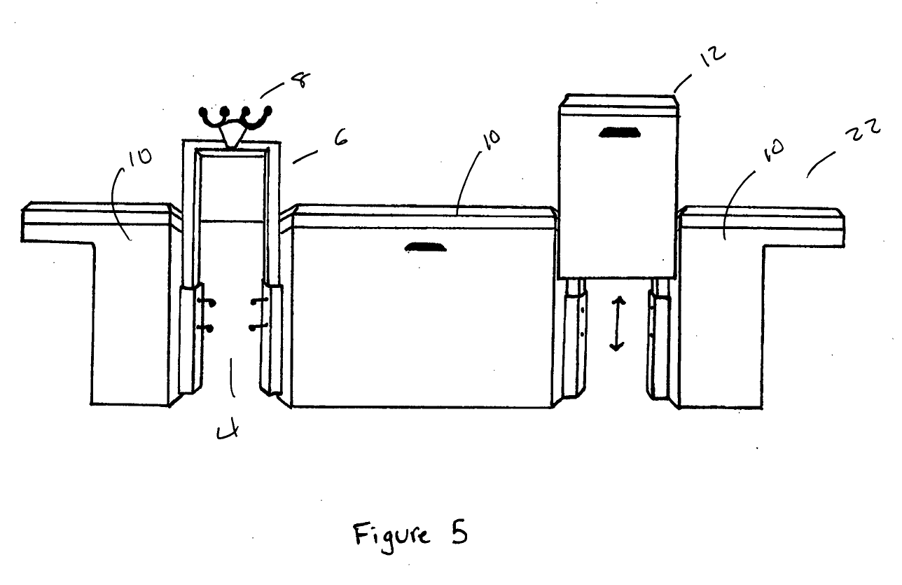

Additionally, the anchoring device is slidably attached to the frame as shown in FIGS. 1 and 5, whereby the height of the device can be adjusted to fit the size of the motorbike to be secured. Furthermore, the anchoring device is pivotively attached to the frame for adjusting its height as shown in FIG. 2. In an embodiment the anchoring device 6 includes a clamping mechanism 8 for securing the forks of the motorbike to the frame 2 and the anchoring device 6 is selectively detachable from the frame 2. The motorbike may also be locked into the anchoring device 6. A stand (not shown) may also be included for interfacing with the anchoring device 6 when the device is removed from the truck bed 14.

As illustrated in FIG. 2 is a further embodiment of the apparatus including storage compartments 10 operatively sized to fit within the frame 2, whereby the storage compartments 10 provide the capacity for housing various items. Additionally included is a pair of tire gap storage compartments 12 pivotively connected to the frame 2 and operatively sized to fit within the tire receiving gaps 4, whereby the tire gap storage compartments 12 conceal the gap 4 when not in use and pivotively fold up and out of the way when the gap 4 houses the motorbike. Other included storage compartments 10 include those housed within the frame on either side of the tire receiving gap and include a hinged lid whose opening is supported by a hydraulic hinge.

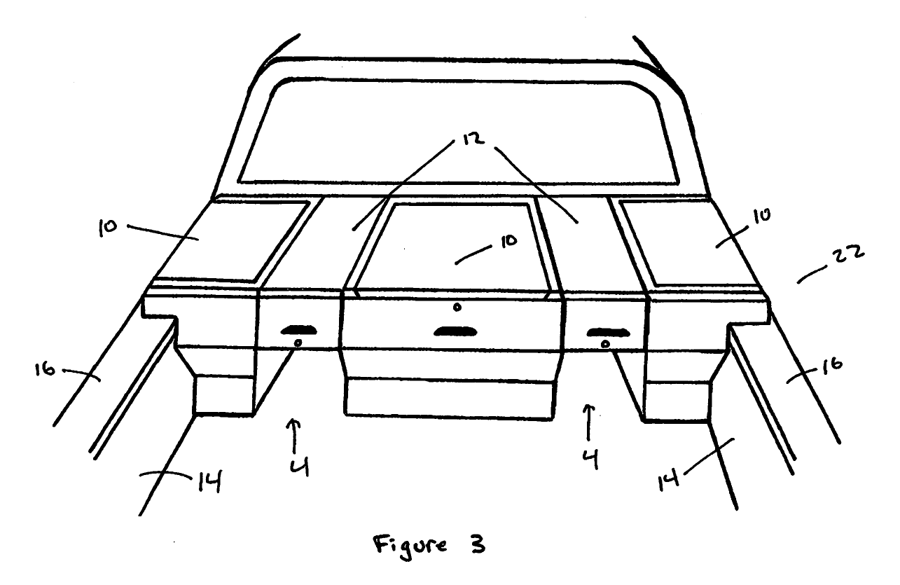

FIGS. 3-5 illustrate the housing 22 embodiment of the apparatus. The figures show tire receiving gaps 4 and the anchoring device 6 and clamping mechanism 8. Further shown are the storage compartments 10 and the tire gap storage compartments 12.

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. An apparatus for securing a motorbike within a truck bed, wherein the truck bed is defined by two opposed parallel sidewalls, a floor and a headwall perpendicular to the opposed sidewalls, the apparatus comprising:
a frame residing within and connected to the truck bed, the frame extending out and perpendicular to the two side walls;
at least two tire receiving gaps formed within the frame; and
an anchoring device for securing the motorbike to the frame, the anchoring device residing within each of the tire receiving gaps.

2. The apparatus of claim 1, wherein the anchoring device is slidably attached to the frame, whereby the height of the device can be adjusted to fit the size of the motorbike to be secured.

3. The apparatus of claim 1, wherein the anchoring device is pivotively attached to the frame, whereby the height of the device can be adjusted to fit the size of the motorbike to be secured.

4. The apparatus of the claim 1, wherein the anchoring device includes a clamping mechanism for securing the forks of the motorbike to the frame and the anchoring device is selectively detachable from the frame.

5. The apparatus of claim 4, further including a stand adapted to receive the selectively detachable anchoring device, whereby the motorbike can be stored apart from the frame.

6. The apparatus of claim 1, further including a locking mechanism attached to the anchoring device for selectively locking the motorbike into the device whereby the theft of the motorbike can be deterred.

7. The apparatus of claim 1, further including storage compartments operatively sized to fit within the frame, whereby the storage compartments provide the capacity for housing various items.

8. The apparatus of claim 7, wherein a pair of tire gap storage compartments are pivotively connected to the frame and are operatively sized to fit within the tire receiving gaps, whereby the tire gap storage compartments conceal the gap when not in use and pivotively fold up and out of the way when the gap houses the motorbike.

9. The apparatus of claim 7, wherein the storage compartments are housed within the frame on either side of the tire receiving gap and include a hinged lid whose opening is supported by a hydraulic hinge.

10. The apparatus of claim 7, wherein the storage compartment is housed within the frame between the tire receiving gaps and include a hinged lid whose opening is supported by a hydraulic hinge.

11. An apparatus for securing a motorbike within a truck bed, wherein the truck bed is defined by two opposed parallel sidewalls, a floor and a headwall perpendicular to the opposed sidewalls, the apparatus comprising:
a housing residing within and connected to the truck bed, the housing extending out and connected to each of the opposed sidewall;
at least two tire receiving gaps formed within the housing; and
an anchoring device for securing the motorbike to the housing, the anchoring device residing within the each of the tire receiving gaps.

12. The apparatus of claim 11, wherein the anchoring device is slidably attached to the housing, and whereby the height of the device can be adjusted to fit the size of the motorbike to be secured.

13. The apparatus of claim 11, wherein the anchoring device is pivotively attached to the housing, and whereby the height of the device can be adjusted to fit the size of the motorbike to be secured.

14. The apparatus of the claim 11, wherein the anchoring device includes a clamping mechanism for securing the forks of the motorbike to the frame and the anchoring device is selectively detachable from the frame and includes a locking mechanism attached to the anchoring device for selectively locking the motorbike into the device whereby the theft of the motorbike can be deterred.

15. The apparatus of claim 11, wherein the housing is adjacent to the headwall.

16. The apparatus of claim 11, further including storage compartments formed with the housing.

17. The apparatus of clam 11, wherein a pair of tire gap storage compartments are pivotively connected to the housing and are operatively sized to fit within the tire receiving gaps, whereby the tire gap storage compartments conceal the gap when not in use and pivotively fold up and out of the way when the gap houses the motorbike.

18. An apparatus for securing a motorbike within a truck bed, wherein the truck bed is defined by two opposed parallel sidewalls, a floor and a headwall perpendicular to the opposed sidewalls, the apparatus comprising:
a housing residing within and connected to the truck bed, the housing extending out and connected to each of the opposed sidewalls, the housing further being located parallel to and adjacent to the headwall;
at least two tire receiving gaps formed within the housing;
storage compartments formed within the housing; and
an anchoring device for securing the motorbike to the housing, the anchoring device residing within the each of the tire receiving gaps and the anchoring device is adjustably attached to the housing whereby the height of the device can be adjusted to fit the size of the motorbike to be secured, the anchoring device include a clamping mechanism for securing the forks of the motorbike to the frame and the anchoring device is selectively detachable from the frame and includes a locking mechanism attached to the anchoring device for selectively locking the motorbike into the device whereby the theft of the motorbike can be deterred.

19. The apparatus of claim 18, wherein the anchoring device is adjustably connected to the frame by an attachment consisting essentially of a pivot attachment, a sliding attachment and combinations thereof.

20. The apparatus of claim 18, wherein a pair of tire gap storage compartments are pivotively connected to the housing and are operatively sized to fit within the tire receiving gaps, whereby the tire gap storage compartments conceal the gap when not in use and pivotively fold up and out of the way when the gap houses the motorbike.
